(19) United States
(12) Patent Application Publication
(10) Pub. No.: US 2019/0219249 A1
(43) Pub. Date: Jul. 18, 2019

(54) LED Light Engine with Integrated Color System

(71) Applicant: Robe Lighting s.r.o., Roznov pod Radhostem (CZ)

(72) Inventors: Tomas David, Zasova (CZ); Jan Vilem, Vsetin (CZ); Pavel Jurik, Prostredni Becva (CZ); Josef Valchar, Prostredni Becva (CZ)

(21) Appl. No.: 16/368,376

(22) Filed: Mar. 28, 2019

(51) Int. Cl. F21V 9/40; H05B 33/08; F21V 9/20; F21V 5/00; F21V 5/04; F21V 13/02

(52) U.S. Cl. CPC F21V 9/40; H05B 33/0863; F21V 9/20; F21Y 2115/10; F21V 5/048; F21V 13/02; F21V 5/007

(57) ABSTRACT

An LED light engine and automated luminaire are provided. The LED light engine includes LED emitters, a first lens array, a color mixing module, second and third lens arrays, and a converging lens. The first lens array includes collimating lenslets corresponding to the LED emitters. The first lens array emits a plurality of light beams corresponding to the LED emitters. Each of the light beams includes substantially parallel light rays. The color mixing module includes dichroic filters that receive the light beams and emit corresponding filtered light beams. The second lens array includes converging lenslets that receive the filtered light beams. The third lens array includes other converging lenslets optically coupled to the second lens array. The converging lens is optically coupled to the third lens array. The second and third lens arrays and the converging lens illuminate a gate in an optical system with the filtered light beams.

### TECHNICAL FIELD OF THE DISCLOSURE

The disclosure generally relates to automated luminaires, and more specifically to a light-emitting diode (LED) based light engine for use in an automated luminaire.

### BACKGROUND

Luminaires with automated and remotely controllable functionality (referred to as automated luminaires) are well known in the entertainment and architectural lighting markets. Such products are commonly used in theatres, television studios, concerts, theme parks, night clubs, and other venues. A typical product will commonly provide control over the pan and tilt functions of the luminaire allowing the operator to control the direction the luminaire is pointing and thus the position of the light beam on the stage or in the studio. Typically, this position control is done via control of the luminaire's position in two orthogonal rotational axes usually referred to as pan and tilt. Many products provide control over other parameters such as the intensity, focus, beam size, beam shape, and beam pattern. In particular, control is often provided for the color of the output beam which may be provided by controlling the insertion of dichroic colored filters across the light beam.

### SUMMARY

In a first embodiment, an LED light engine includes a plurality of LED emitters, a first lens array, a color mixing module, a second lens array, a third lens array, and a converging lens. The first lens array includes a first plurality of collimating lenslets that corresponds to the plurality of LED emitters. The first lens array is optically coupled to the plurality of LED emitters and configured to emit a plurality of light beams corresponding to the plurality of LED emitters. Each of the plurality of light beams includes substantially parallel light rays. The color mixing module includes dichroic filters that receive the plurality of light beams and emit a corresponding plurality of filtered light beams. The second lens array includes a first plurality of converging lenslets that are optically coupled to the color mixing module and configured to receive the plurality of filtered light beams emitted by the color mixing module. The third lens array includes a second plurality of converging lenslets optically coupled to the second lens array. The converging lens is optically coupled to the third lens array. The second and third lens arrays and the converging lens are configured to illuminate a gate with the plurality of filtered light beams received from the color mixing module.

In a second embodiment, an automated luminaire includes an LED light engine, an optical system, and a controller. The optical system is optically coupled to the LED light engine. The controller is electrically coupled to the LED light engine and to a data link and is configured to control physical and electrical functions of the LED light engine in response to control signals received via the data link. The includes a plurality of LED emitters, a first lens array, a color mixing module, a second lens array, a third lens array, and a converging lens. The first lens array includes a first plurality of collimating lenslets that corresponds to the plurality of LED emitters. The first lens array is optically coupled to the plurality of LED emitters and configured to emit a plurality of light beams corresponding to the plurality of LED emitters. Each of the plurality of light beams comprises substantially parallel light rays. The color mixing module includes dichroic filters that are configured to receive the plurality of light beams and to emit a corresponding plurality of filtered light beams. The second lens array includes a first plurality of converging lenslets that are optically coupled to the color mixing module and configured to receive the plurality of filtered light beams emitted by the color mixing module. The third lens array includes a second plurality of converging lenslets optically coupled to the second lens array. The converging lens is optically coupled to the third lens array. The second and third lens arrays and the converging lens are configured to illuminate a gate of the optical system with the plurality of filtered light beams received from the color mixing module

### BRIEF DESCRIPTION OF THE DRAWINGS

For a more complete understanding of the present disclosure and the advantages thereof, reference is now made to the following description taken in conjunction with the accompanying drawings in which like reference numerals indicate like features and wherein:

FIG. 1 presents a schematic view of a multiparameter automated luminaire system according to the disclosure;

FIG. 2 presents a block diagram of a control system for an automated luminaire according to the disclosure;

FIG. 3 presents an exploded orthogonal view of an LED light engine according to the disclosure;

FIG. 4 presents an assembled orthogonal view of the LED light engine of FIG. 3;

FIG. 5 presents an orthogonal view of an LED light engine according to the disclosure, comprising the LED light engine of FIG. 4; and

FIG. 6 shows a representational schematic side view of the LED light engine of FIG. 3, illustrating exemplary light paths.

### DETAILED DESCRIPTION

Preferred embodiments are illustrated in the figures, like numerals being used to refer to like and corresponding parts of the various drawings.

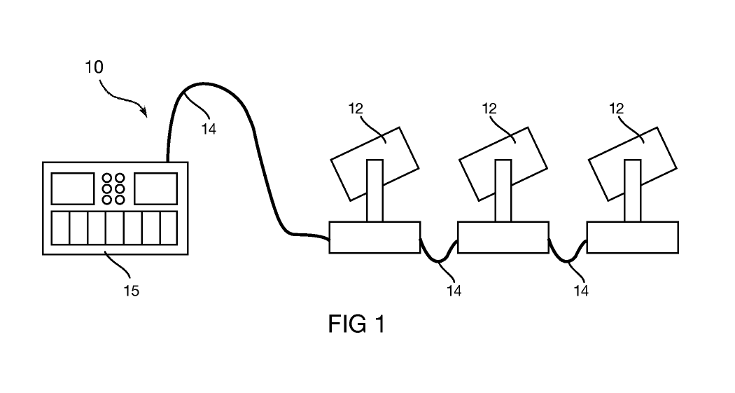

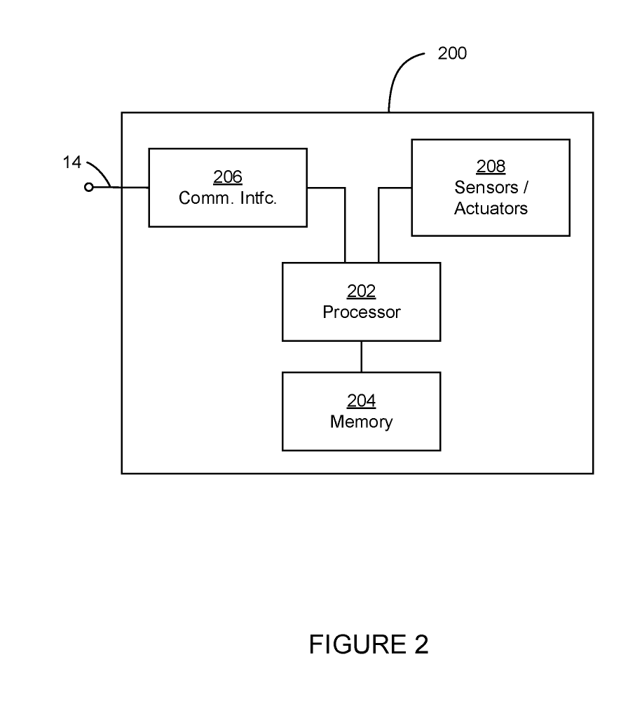

FIG. 1 presents a schematic view of a multiparameter automated luminaire system 10 according to the disclosure. The multiparameter automated luminaire system 10 includes a plurality of multiparameter automated luminaires 12 according to the disclosure. The automated luminaires 12 each contains on-board a light source, color changing devices, light modulation devices, pan and/or tilt systems to control an orientation of a head of the automated luminaire 12. Mechanical drive systems to control parameters of the automated luminaire 12 include motors or other suitable actuators coupled to control electronics, as described in more detail with reference to FIG. 2. In addition to being connected to mains power either directly or through a power distribution system, each automated luminaire 12 is connected in series or in parallel via data link 14 to one or more control desks 15. An operator typically controls the parameters of the automated luminaires 12 via the control desk 15.

The automated luminaires 12 may include stepper motors to provide the movement for internal optical systems. Examples of such optical systems may include gobo wheels, effects wheels, and color mixing systems, as well as prism, iris, shutter, and lens movement.

Automated luminaires 12 may include an LED based light source designed to collate and direct light through the optical systems installed in the automated luminaire 12. The assembly of the LED light sources along with associated collimating and directing optics may be referred to as a light engine. LED light engines may contain a single color of LED, such as white, or may contain a range of colors, each controllable individually so as to provide additive mixing of the LED outputs. In the case of white light LED light engines, the light engine is often followed in the optical train by a color mixing section comprising a number of dichroic filters which can be controlled so as to move across the light beam exiting from the light engine. By suitable choice of these filters and their accurate positioning, it is possible for the operator to produce a wide range of colors of the light beam. For example, using three sets of independent dichroic filters in cyan, magenta, and yellow allows the operator to mix a broad spectrum of colors, from blue through red, and also to adjust the saturation of those colors.

One disadvantage of systems with a light engine separate from the color mixing and other optical effects is that the optical path becomes longer, and less efficient. Disclosed herein is an improved LED light engine that incorporates the color mixing system within it. Among other benefits, an LED light engine according to the disclosure improves the quality—in particular the homogenization—of the color mixing, improves the efficiency of the luminaire, and reduces the size of the luminaire.

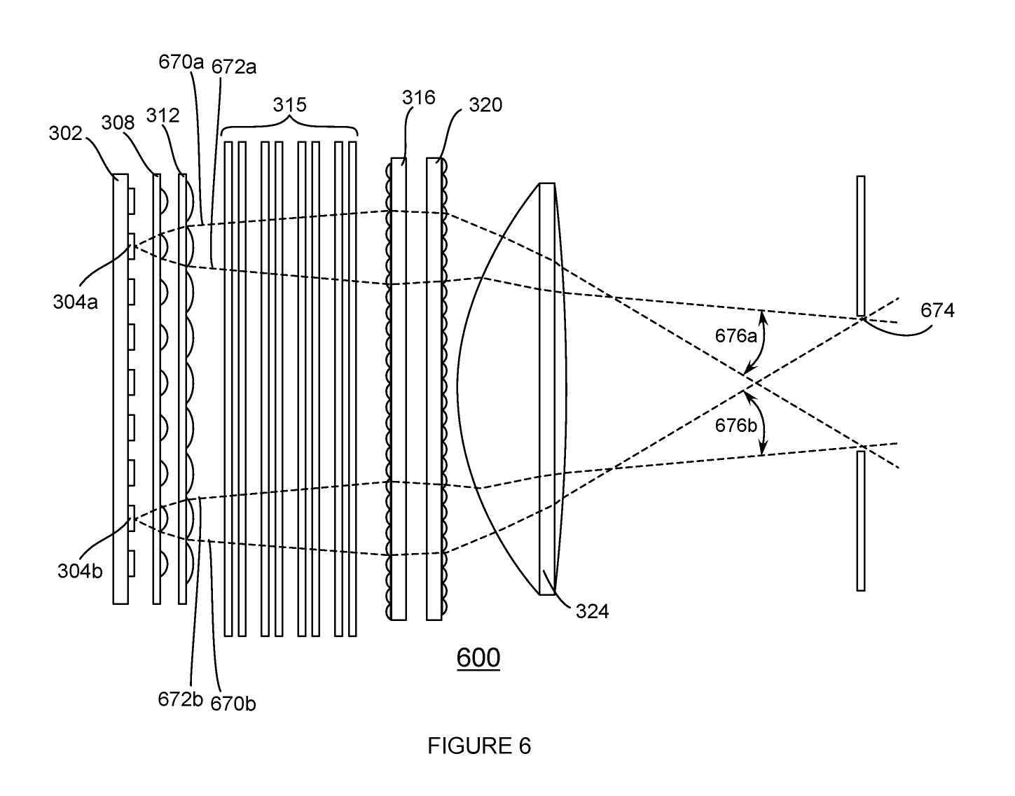

FIG. 2 presents a block diagram of a control system (or controller) 200 for an automated luminaire 12 according to the disclosure. The control system 200 is suitable for use with the LED light engine and color mixing system of FIG. 6 or other systems according to the disclosure. The control system 200 is also suitable for controlling other control functions of the automated luminaire system 10. The control system 200 includes a processor 202 electrically coupled to a memory 204. The processor 202 is implemented by hardware and software. The processor 202 may be implemented as one or more Central Processing Unit (CPU) chips, cores (e.g., as a multi-core processor), field-programmable gate arrays (FPGAs), application specific integrated circuits (ASICs), and digital signal processors (DSPs).

The processor 202 is further electrically coupled to and in communication with a communication interface 206. The communication interface 206 is coupled to, and configured to communicate via, the data link 14. The processor 202 is also coupled via a control interface 208 to one or more sensors, motors, actuators, controls and/or other devices. The processor 202 is configured to receive control signals from the data link 14 via the communication interface 206 and, in response, to control the LED light engine, color mixing systems and other mechanisms of the automated luminaire system 10 via the control interface 208.

The control system 200 is suitable for implementing processes, dichroic mixing module control, LED brightness control, and other functionality as disclosed herein, which may be implemented as instructions stored in the memory 204 and executed by the processor 202. The memory 204 comprises one or more disks and/or solid-state drives and may be used to store instructions and data that are read and written during program execution. The memory 204 may be volatile and/or non-volatile and may be read-only memory (ROM), random access memory (RAM), ternary content-addressable memory (TCAM), and/or static random-access memory (SRAM).

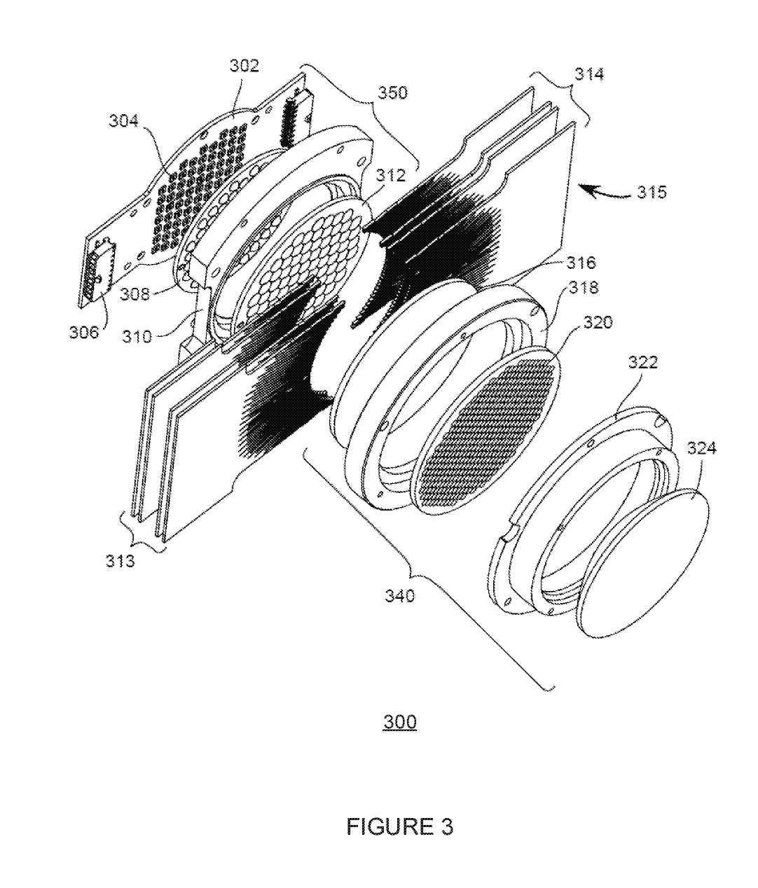

FIG. 3 presents an exploded orthogonal view of an LED light engine 300 according to the disclosure. An array of a plurality of LED emitters 304 are mounted on substrate 302 which has electrical connector 306 through which the LED emitters can be powered. LED emitters 304 may be of a single color such as white or may be in a plurality of colors. In either case the individual LED emitters 304 may be configured to be controllable as a single group, in multiple groups, or individually depending on the requirements of the luminaire. Each LED emitter 304 may have a primary optic comprising a reflector, total internal reflection (TIR) lens, or other suitable optic.

LED emitters 304 may be simple LEDs or may comprise an LED emitter coupled with a phosphor. In further embodiments LED emitters 304 may comprise LED laser diodes with or without an associated phosphor.

Each LED emitter 304 is associated with a corresponding pair of collimating lenslets on lens arrays 308 and 312. Each LED emitter 304 is optically coupled to and optically aligned with its corresponding collimating lenslet on lens array 308. Each collimating lenslet on lens array 308 is optically coupled to and optically aligned with its corresponding collimating lenslet on lens array 312. That is, light from each LED emitter 304 passes first through its corresponding collimating lenslet on lens array 308, and then through its corresponding collimating lenslet on lens array 312.

Light rays of the resulting light beam from each LED emitter 304 and its collimating lenslets are substantially parallel. In some embodiments the term “substantially parallel” means that the half cone angle of the light beam exiting the second collimating lenslet on lens array 312 is 10° (10 degrees). In other embodiments, “substantially parallel” means that this half cone angle may be as low as 5° or as high as 20°. LED emitters 304, substrate 302, collimating lens array 308 and collimating lens array 312 may be assembled with mounting plate 310 and electrical connector 306 so as to form a unitary LED module 350. In the embodiment disclosed and described, all LED emitters 304 emit white light, however other embodiments may use differently colored LED emitters.

Although lens arrays 308 and 312 are constructed on two separate substrates, in other embodiments, lens arrays 308 and 312 may be fabricated on opposite sides of a single (common) substrate. Lens arrays 308 and 312 and their substrate(s) according to the disclosure may be molded from a material comprising glass or a transparent polymer. In still other embodiments, lens arrays 308 and 312 may be fabricated from multiple individual collimating lenslets. In yet other embodiments, lens arrays 308 and 312 may be replaced with a single lens array fabricated from glass or other optical material having a higher refractive index than lens arrays 308 and 312 or comprising collimating lenslets having an aspherical profile.

The collimated and substantially parallel light beams emitted by the collimating lens array 312 then pass through dichroic filters 313 and 314, which comprise color mixing module 315. Dichroic filters 313 and 314 may be individual panels of a dichroic coated transparent substrate which are configured so as to be positioned with the dichroic coating out of the light beams, fully covering the light beams, or in an intermediate position partially covering the light beams. Color mixing module 315 comprises four pairs of dichroic filters, one pair each in cyan, yellow, magenta, and color temperature orange (CTO). By independently and coordinately positioning the pairs of filters, a user may accurately control the color and color temperature of the filtered light beams.

Dichroic filters color the light passing through them differently as the angle of incidence of the light on the filter varies, thus more predictable and consistent color is obtained if a light beam passing through the dichroic filter is both perpendicular to the filter, and close to parallel, as the color mixing system of the present disclosure provides. Systems having dichroic filters mounted after the light engine assembly (rather than inside the light engine assembly, as disclosed herein), may use additional relay, field, or collimating lenses to further collimate the light beam produced by the light engine assembly so as to pass through the dichroic filters at a sufficiently narrow angle so as to avoid the effects of less-perpendicular and/or less-parallel beams, as well as to allow the beam to pass entirely through all optical effects. Such additional lenses reduce the light output of such a system, as well as increasing its cost, weight, and length.

Although color mixing module 315 includes four pairs of dichroic filters that are moved linearly across the light beams, other embodiments may include, but are not restricted to, systems with any number of dichroic filters. Such filters may be configured as single linear flags, rotary discs, wheels, or arcuate flags. For example, some embodiments may include three dichroic filters configured as discs that may be rotated across the light beams.

Dichroic filters 313 and 314 each comprises a rectangular, clear substrate whose width (short dimension) completely spans a combined width of the light beams and whose length (long dimension) is several times longer than the combined width of the light beams. The substrate is coated with dichroic material in a pattern comprising a first portion at a first end that is of a size to fully cover the light beam. The first portion abuts a second portion that comprises a plurality of fingers of dichroic material whose width diminishes toward a second end of the substrate. In this way, the dichroic material of the dichroic filters 313 and 314 fully filter the light beams at the first end, and providing diminishing filtration as they are removed linearly from the light beams.

In other embodiments, the dichroic filter material may be etched, cut, or similarly configured in other patterns on a clear substrate, to form regions of differing amounts of dichroic filter interspersed with regions of clear substrate. In still other embodiments, both the dichroic filter and underlying substrate may be cut into a pattern with varying density, such as tapered fingers, such that regions of differing amount of dichroic filter are interspersed with areas where both dichroic filter and substrate have been removed.

In further embodiments, a clear substrate may be coated with a varying dichroic material, such that different regions of the coated substrate filter the light beams to different colors. In still other embodiments, differing portions of a substrate may be coated with different dichroic materials, where the portions are of sufficient size to fully cover the light beam and each portion produces a differing consistent color across the entirety of the light beam. In yet other embodiments, two or more wheels may include removable individual fully coated dichroic filters that each fully covers the light beams.

The dichroic filters 313 and 314 (and other patterned dichroic filters) may produce a parti-colored light beam, wherein parts of the light beams from some LED emitters 304 in the LED module 350 are colored by the filter, while other parts of the light beams (or other light beams) are unfiltered and retain the original color of the LED emitter 304.

After passing through dichroic filters 313 and 314, the combined light beam produced by all the light beams from each LED emitter 304 in the LED module 350, passes through fly-eye lens array 316 and fly-eye lens array 320. The fly-eye lens arrays 316 and 320 may be referred to as homogenizing or integration lens arrays. Each of the fly-eye lens arrays 316 and 320 comprise a plurality of converging lenslets.

The fly-eye lens arrays 316 and 320 are configured, along with converging lens 324, such that the beam originating from each individual LED emitter 304 illuminates a gate (or stop) of the automated luminaire (as described with reference to FIG. 6). In a projection optical system according to the disclosure, the gate is an imaging area or region of through which the beams from the LED emitters 304 pass in order to illuminate an iris, gobo, or other image-generating optical device. In a wash optical system according to the disclosure, a gate is a region of the optical system where the beams from the LED emitters 304 overlap before passing through further optical devices to be formed into an even, soft-edged beam. A gate may be a physical (e.g., an aperture as shown in FIG. 6) or may be ‘virtual’ (e.g., a narrow region in the optical system where the beams from the LED emitters 304 overlap).

The fly-eye lens arrays 316 and 320 and the converging lens 324 are configured to overlap the light beams from each LED emitter 304 onto the gate area, providing full integration of brightness variations and homogenization of colors, thus producing a light beam with a smooth illumination and single color at the gate. Fly-eye lens array 316, fly-eye lens array 320, and converging lens 324 may be assembled with mounting plates 318 and 322 so as to form a unitary integration module 340.

In a further embodiment, integration module 340 may be removable from the path of the light beams either manually or through a motor and mechanism that may be controlled by the user. For example, integration module 340 may be mounted on a pivoting arm coupled to a motor and mechanism so that the integration module 340 can be controllably swung out of or into the path of the light beam from the LED emitters. When removed from the path of the light beams, the combined light output from the LED light engine will no longer be fully homogenized, but may be higher in intensity and may also be useful as an effect.

LED light engines according to the disclosure may be contrasted with prior art light engines where blending of beams from multiple LED emitters is performed before the light beam passes through the dichroic filters, possibly requiring additional optical elements to homogenize the colored light.

Although fly-eye lens arrays 316 and 320 are constructed on two separate substrates, in other embodiments, fly-eye lens arrays 316 and 320 may be on opposite sides of a single substrate. Fly-eye lens arrays and their substrate(s) according to the disclosure may be molded from a material comprising glass or a transparent polymer. In still other embodiments, fly-eye lens arrays may be fabricated from multiple individual converging lenslets. In fly-eye lens arrays 316 and 320, the converging lenslets abut each other, leaving no substrate exposed between converging lenslets. In other embodiments, substrate may be exposed between some or all of the converging lenslets.

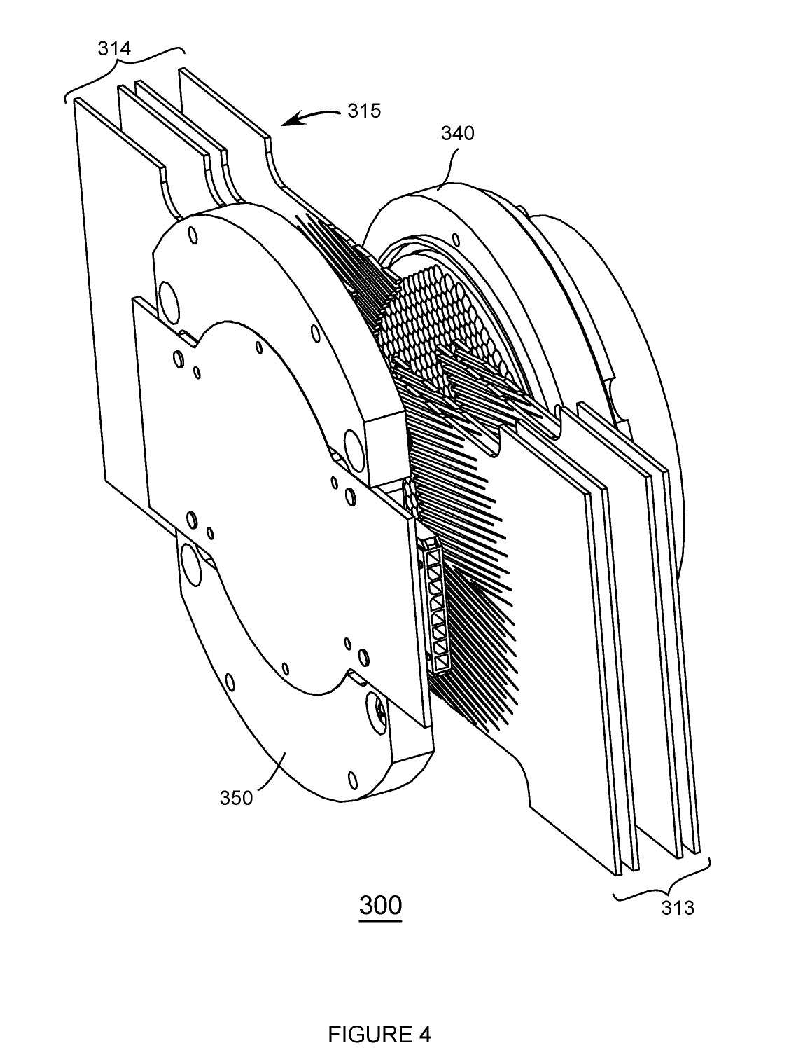

FIG. 4 presents an assembled orthogonal view of the LED light engine 300 of FIG. 3. The final assembly comprises three separate modules, LED module 350, color mixing module 315, and integration module 340. In an embodiment of the disclosure, each of these modules may be exchanged and replaced independently so as to aid the serviceability of the luminaire. In particular the disclosed system makes it possible and simple to replace the LED module 350 alone for service or repair without having to also replace the integration module 340 or color mixing module 315. This provides significant advantage and cost reduction for the user. Similarly, the integration module 340 or color mixing module 315 may be easily removed for cleaning or maintenance. In a further embodiment, the circuit board comprising at least substrate 302 and LED emitters 304 may be removed from the system independently of module 350. This provides a method for the user to replace the circuit board substrate and its LED emitters as the LEDs age, or if any LEDs fail. The manufacturer can provide this as a replacement component at a much lower cost than supplying the entire light engine 300, or LED module 350.

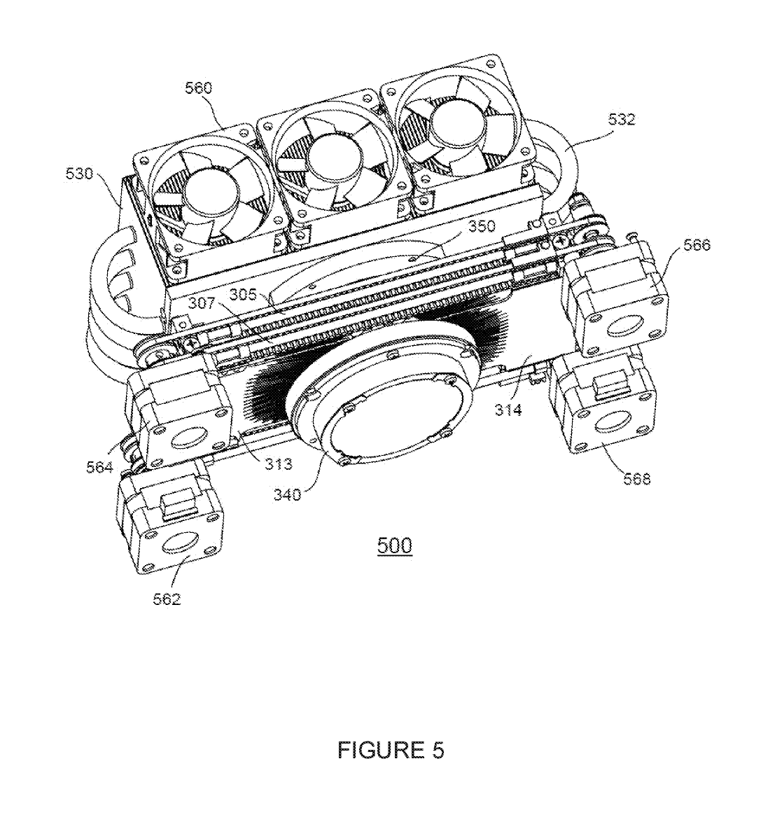

FIG. 5 presents an orthogonal view of an LED light engine 500 according to the disclosure, comprising the LED light engine 300 of FIG. 4. The LED light engine 500 further includes a heat sink 530, coupled to the LED emitter substrate 302 by heat pipes 532. The heat pipes 532 conduct a working fluid between the LED emitter substrate 302 and the heat sink 530 to transfer heat generated by the LED emitters 304 to the heat sink 530. Fans 560 blow air through the heat sink 530. Other embodiments may use other suitable techniques to dissipate heat from the LED emitters 304.

The LED light engine 500 also includes motors 562, 564, 566, and 568, each of which is mechanically coupled to a belt (two belts are visible and indicated by 305 and 307, and two other belts underneath the assembly are not shown). Each belt is coupled to both filters of a single-color pair of filters from dichroic filters 313 and 314 and is configured to position the pair of filters into and out of the light beam, moving the pair from opposite sides of the light beam.

The controller 200 (described with reference to FIG. 2) may be coupled to the fans 560 and configured to control speeds of the fans 560 to control physical functions of the LED light engine 300. The controller 200 is coupled to the motors 562, 564, 566, and 568 and configured to control positions of the dichroic filters 313 and 314 in the light beams emitted by the collimating lens array 312 to produce a desired color of light beam at the gate, in response to a control signal received via data link 14.

FIG. 6 shows a schematic side view 600 of the LED light engine 300 of FIG. 3, illustrating exemplary light paths. LED emitter 304a emits a light beam 676a bounded by light rays 670a and 672a. LED emitter 304b emits a light beam 676b bounded by light rays 670b and 672b. The light beam 676a from LED emitter 304a is collimated by a collimating lenslet in the lens array 308 and a collimating lenslet in the lens array 312, so as to provide a nearly parallel beam as it passes through the color mixing module 315. The now parti-colored beam 676a is then integrated and homogenized by fly-eye lens array 316 and fly-eye lens array 320 before passing through converging lens 324 and being directed through an aperture gate 674 of the luminaire. Light beam 676b follows a similar path through the LED light engine 300.

While a single pair of collimating lenslets in lens arrays 308 and 312 are optically coupled to each of the light beams 676a and 676b, the lenslets in the fly-eye lens arrays 316 and 320 are smaller, such that each of the light beams 676a and 676b pass through a plurality of adjacent converging lenslets, which collectively operate to homogenize and integrate the parti-colored beams emerging from the color mixing module 315.

The light beams 676a and 676b overlap at the gate 674. That is, the LED light engine 300 directs the light beams from each of the LED emitters 304 to cover the entire gate 674. As a result, the light beams from the LED emitters 304 overlap at gate 674 and the resultant combined light beam is well mixed and homogenized, combining the light from all LED emitters 304 and all the variations of color after passing through the color mixing module 315 into a single colored light beam. In embodiments where color filters are used that produce a consistent color across all beams from all LED emitters 304, the light beam at gate 674 has a consistent brightness (or even illumination) across the gate 674.

In a further embodiment the LED emitters may comprise two or more independently controllable groups of LEDs with different parameters. For example, two groups of LED emitters may differ in at least one parameter selected from but not limited to color, color temperature, Dᵤᵥ (distance to the blackbody locus), spectral output, color rendering, metameric mix. The relative outputs (brightnesses) of the groups may then be adjusted during a calibration procedure to provide an output that meets a desired specification and improves matching between different luminaires. This may be used to correct for manufacturing variances between LED emitters. The LED emitter groups may all be white emitters with varying characteristics or may be a mix of colors.

The controller 200 may be electrically coupled to the LED emitters of such an embodiment and configured to control electrical functions of the LED light engine 300—e.g., the brightness of some or all such groups to meet the desired specification and/or to correct for the manufacturing variances. The controller may store information relating to results from the calibration procedure for use in such brightness control. In an embodiment with two or more groups of LED emitters emitting light of different colors, the controller may be configured to control the relative brightness of some or all such groups.

While only some embodiments of the disclosure have been described herein, those skilled in the art, having benefit of this disclosure, will appreciate that other embodiments may be devised which do not depart from the scope of the disclosure. While the disclosure has been described in detail, it should be understood that various changes, substitutions and alterations can be made hereto without departing from the spirit and scope of the disclosure.

What is claimed is:

1. A light-emitting diode (LED) light engine, comprising:
a plurality of LED emitters;
a first lens array comprising a first plurality of collimating lenslets corresponding to the plurality of LED emitters, the first lens array optically coupled to the plurality of LED emitters and configured to emit a plurality of light beams corresponding to the plurality of LED emitters, each of the plurality of light beams comprising substantially parallel light rays;
a color mixing module comprising dichroic filters, configured to receive the plurality of light beams and to emit a corresponding plurality of filtered light beams;
a second lens array comprising a first plurality of converging lenslets optically coupled to the color mixing module and configured to receive the plurality of filtered light beams emitted by the color mixing module;
a third lens array comprising a second plurality of converging lenslets optically coupled to the second lens array; and
a converging lens optically coupled to the third lens array, the second and third lens arrays and the converging lens configured to illuminate a gate with the plurality of filtered light beams received from the color mixing module.

2. The LED light engine of claim 1, further comprising:
a fourth lens array comprising a second plurality of collimating lenslets corresponding to the first plurality of collimating lenslets, the fourth lens array optically coupled to the first lens array, the first and fourth lens arrays configured to emit the plurality of light beams corresponding to the plurality of LED emitters.

3. The LED light engine of claim 2, wherein all of the plurality of LED emitters emit white light.

4. The LED light engine of claim 2, wherein:
each collimating lenslet of the first plurality of collimating lenslets is optically aligned with a corresponding one of the plurality of LED emitters; and
each collimating lenslet of the second plurality of collimating lenslets is optically aligned with a corresponding one of the first plurality of collimating lenslets.

5. The LED light engine of claim 2, wherein the first and fourth lens arrays are fabricated on opposite sides of a common substrate.

6. The LED light engine of claim 2, wherein the second and third lens arrays are fabricated on opposite sides of a common substrate.

7. The LED light engine of claim 2, wherein the color mixing module comprises cyan, yellow, magenta, and color temperature orange dichroic filters.

8. The LED light engine of claim 2, wherein the plurality of LED emitters, the first lens array, and the fourth lens array are mechanically coupled to form an LED module, the LED module being mechanically coupled to and removable from the color mixing module.

9. The LED light engine of claim 8, wherein the plurality of LED emitters are mechanically coupled to and removable from the LED module.

10. The LED light engine of claim 2, wherein the second lens array, the third lens array, and the converging lens are mechanically coupled to form an integration module, the integration module being mechanically coupled to and removable from the color mixing module.

11. The LED light engine of claim 2, wherein each of the plurality of light beams passes through a plurality of adjacent converging lenslets in each of the second lens array and the third lens array.

12. An automated luminaire, comprising:
an LED light engine;
an optical system optically coupled to the LED light engine; and
a controller electrically coupled to the LED light engine and to a data link and configured to control physical and electrical functions of the LED light engine in response to control signals received via the data link,
the LED light engine comprising:
a plurality of LED emitters;
a first lens array comprising a first plurality of collimating lenslets corresponding to the plurality of LED emitters, the first lens array optically coupled to the plurality of LED emitters and configured to emit a plurality of light beams corresponding to the plurality of LED emitters, each of the plurality of light beams comprising substantially parallel light rays;
a color mixing module comprising dichroic filters, optically coupled to the second lens array and configured to receive the plurality of light beams and to emit a corresponding plurality of filtered light beams;
a second lens array comprising a first plurality of converging lenslets optically coupled to the color mixing module and configured to receive the plurality of filtered light beams emitted by the color mixing module;
a third lens array comprising a second plurality of converging lenslets optically coupled to the second lens array; and
a converging lens optically coupled to the third lens array, the second and third lens arrays and the converging lens configured to illuminate a gate of the optical system with the plurality of filtered light beams received from the color mixing module.

13. The automated luminaire of claim 12, wherein the LED light engine further comprises:
a fourth lens array comprising a second plurality of collimating lenslets corresponding to the first plurality of collimating lenslets, the fourth lens array optically coupled to the first lens array, the first and fourth lens arrays configured to emit the plurality of light beams corresponding to the plurality of LED emitters.

14. The automated luminaire of claim 13, wherein:
the color mixing module comprises a plurality of dichroic filters; and
the controller is configured to position one or more dichroic filters of the plurality of dichroic filters in the plurality of light beams.

15. The automated luminaire of claim 14, wherein the plurality of dichroic filters comprises cyan, yellow, magenta, and color temperature orange dichroic filters.

16. The automated luminaire of claim 13, wherein the controller is configured to control a brightness of one or more LED emitters of the plurality of LED emitters.

17. The automated luminaire of claim 16, wherein the controller is configured to control the brightness of the one or more LED emitters based upon stored information relating to results from a calibration procedure performed upon the plurality of LED emitters.

18. The automated luminaire of claim 16, wherein two or more groups of LED emitters emit light of different colors and the controller is configured to control a relative brightness of some or all of the two or more groups of LED emitters.

19. The automated luminaire of claim 13, wherein the controller is electrically coupled to the optical system and configured to control one or more physical or electrical functions of the optical system in response to control signals received via the data link.
